(19) United States
(12) Patent Application Publication
(10) Pub. No.: US 2006/0271394 A1
(43) Pub. Date: Nov. 30, 2006

(54) Dietary Restrictions/Preferences Tracking and Meal Planning Process and System

(76) Inventor: JOANNE T. KELLY, BOULDER, CO (US)

Correspondence Address: CHRISTOPHER J. KULISH, ESQ, HOLLAND & HART LLP, P. O. BOX 8749, DENVER, CO, 80201-8749, US

(21) Appl. No.: 11/420,975

(22) Filed: May 30, 2006

Related U.S. Application Data
(60) Provisional application No. 60/595,016, filed on May 27, 2005.

(51) Int. Cl. G06Q 99/00; G06Q 30/00; G06Q 50/00

(52) U.S. Cl. 705/1; 705/15

(57) ABSTRACT

Software resident in a computer- or Web-accessible database allows event planners, hosts and hostesses to track their guests' food and beverage restrictions and preferences. Individuals enter their dietary needs/restrictions/preferences in the database. When a host or hostess enters a list of potential attendees to an event, the invention generates a plurality of recipes that are consistent with the potential attendees' dietary needs/restrictions/preferences.

### FIELD OF THE INVENTION

The present invention relates to a computer-based system and method for tracking a person's dietary preferences/restrictions and/or for planning a meal at an event at which a number of potential attendees are likely to have varying food preferences.

### BACKGROUND OF THE INVENTION

United States Patent Application Publication No. 2001/0025279 entitled “METHOD AND SYSTEM FOR PLANNING CUSTOMIZED MENU” wherein an interactive customized menu-method is based upon user established menu criteria from a list of recipes corresponding to that criteria. A user picks a menu from a display of recipes. The user is allowed to customize the menu by mixing and matching menus. Planning an event is discussed, taking into consideration dietary or nutritional restrictions and preferred ingredients.

United States Patent Application Publication No. 2003/0225731 entitled “METHOD AND SYSTEM FOR OPTIMIZED DIETARY MENU PLANNING” wherein dietary menus are provided for an individual by composing a database of both preferences and desired physiological change(s) for that individual.

United States Patent Application Publication No. 2003/0208409 entitled “METHOD AND APPARATUS FOR DIET CONTROL” wherein a portable communication device is used to inquire about restaurants having menus that meet an individual's criteria requirements.

United States Patent Application Publication No. US 2003/0036977 entitled “ORDER AND INVENTORY INFORMATION MANAGEMENT SYSTEM” wherein a system for tracking customer orders is provided for inventory maintenance.

United States Patent Application Publication No. US 2003/0158465 wherein preparation criteria for an item is identified in conjunction with a dietary restriction, and if necessary, to provide a preparation plan compatible with the dietary restriction.

U.S. Pat. No. 5,832,446 entitled “INTERACTIVE DATABASE METHOD AND SYSTEM FOR FOOD AND BEVERAGE PREPARATION” which discloses a system and method for automated cooking instruction in which a database is accessed using a list of ingredients along with potential cooking steps. Provision of audio instructions is provided as an option.

Each of the patent documents identified in the Background portion of this application is incorporated by reference in its entirety.

### SUMMARY OF THE INVENTION

The present invention provides a Web-accessible or computer network-accessible database, or software that is resident in a personal computer (PC), that allows event planners, hosts and hostesses to track their guests' food and beverage restrictions and preferences. When a host or hostess (hereafter hostess) enters a list of potential attendees, the invention generates a plurality of recipes that are consistent with the potential attendees' dietary needs/preferences. In addition, the invention allows the hostess to track what they served their guests on previous occasions, and provides a place for comments on the meal.

In summary, when a hostess invites guests to a meal, she asks them to make sure they are registered on the Web-accessible database, provide a dietary-profile to the database, and enable her to access their guest-profiles.

A given guest goes to the Web-accessible database and selects either an “Enter a new dietary profile” or an “Update my current profile” option that is provided by the database.

Before a user uses the Web-accessible database of the invention for the first time, he/she must register, for example by filling out a registration form (FIG. 7). To access the database on subsequent visits the user must enter both the user's e-mail address and a password. As used herein the term “user” means a user of the Web-accessible database, for example, a host/hostess, a guest or a member of a group or club.

The guest is then presented with a profile-form (See FIG. 5) whereby for a given food item (for example apples) the guest selects from a number of categories (for example the five categories shown in FIG. 5) any restrictions/allergies/preferences the pertain to the guest (for example “Will not/cannot eat”).

Any given guest may enter profiles of other family members if the guest chooses to do so.

When a guest is finished providing the above-described dietary profile(s), the names and e-mail addresses of people to whom the guest grants permission to access the profile(s) is entered, and an e-mail message is automatically sent to these people to notify them that “John Doe's” profile (or updated profile) is available on the Web-accessible database (perhaps with a direct link to the profile).

When a hostess begins to plan a gathering, she goes to the Web-accessible database site and selects a “Plan a gathering” option. In doing so she must enter her e-mail address and password, whereupon she is presented with a blank planning panel or screen.

She then fills in a name for the gathering (for example, “2005 birthday dinner for Susan”) and the date of the gathering. She then enters her guests' names and email addresses (which she can select from her address book instead of entering manually if she has entered them previously).

If her guests have already given the hostess access to their profiles, their profiles will automatically populate the hostess' planning panel. If any given guest has a profile in the Web-accessible database, but the hostess has not been granted access to the profile, the hostess can hit a cursor-selectable button (hereafter button) on a display screen in order to send an e-mail to that guest requesting access to the profile. If a hostess wants to invite a guest, but no profile exists for that guest within the Web-accessible database, the hostess can hit a button in order to send an e-mail to that guest requesting the guest to connect to the Web-accessible database and then provide a profile for storage in the database.

The hostess can also enter her own version of a profile for any given guest, based on her own knowledge of that guest's restrictions/preferences, which profile can then be saved in the database. If that guest later profiles him/herself, the hostess can choose to use either her profile or to use the guest's actual profile.

Once the hostess has profiles for all her guests, she can view the guests dietary preferences/restrictions in aggregate or individually. In addition, the hostess can hit a “Get recipes” button, whereupon the hostess is presented with a page or screen whereby she can choose particular recipe types (for example appetizers, main dishes, salads, desserts, etc), and cuisine-type (for example, Italian, French, Thai, etc.) and special-occasion (such as Christmas, etc.).

The hostess can choose to have the recipes returned in an order whereby recipes that include items that are on most of her guests' “favorites” lists are at the top of the list, and wherein the names of the guests who have listed the ingredients as “favorites” will appear in a “favorites” box next to a given recipe.

Recipes that the hostess chooses are placed in a “Recipes under consideration” field in a planning panel.

A hostess can enter a given recipe to the Web-accessible recipe database for her use only.

Once the hostess has chosen her recipes from the output of the Web-accessible database, she can hit a “Wine pairings” button, whereupon the database returns a list of wines that work well with her chosen recipes.

If a given recipe selected for an event came from the Web-accessible database, a link to that recipe remains in the event archive. After an event is over, a hostess can update the event archive, delete the names of people who did not come, including comments by guests, and perhaps even make notes on decorations, clothing, etc.

In addition, a field is provided whereby a hostess can enter what she actually served, along with comments on the recipes; a hostess can rate the recipes, and the hostess can chose whether or not to make her comments visible to others who access the same recipes.

When a hostess wants to go back and look at a previous event, she goes to the Web-accessible database site and selects an “Access my event archive” option where she is presented with a list of the names and dates of the events she has entered into the Web-accessible database site, whereupon she can open the archive of the previous event that she wants to view.

In addition, the invention provides the ability for groups (for example church groups or senior citizens clubs or groups) to view the aggregate dietary restrictions/preferences of all of their members who have entered a dietary profile in the Web-based database of the invention.

As one non-limiting expression of the present invention, the invention provides a software-supported system/apparatus wherein;
(1) a first data library is provided, this first data library including a plurality of profiles, one profile being provided for each of a large plurality of individual guests that could be invited to an event, and each of these profiles including information such as dietary information that is unique to each individual guest;
(2) a second data library is provided, this second data library including a plurality of menu items such as recipes of foods that could be provided for guests that are invited to a given event;
(3) a smaller list of guests to be invited to a given function or event is provided; and
(4) a set of menu items, or recipes for menu items, for this given function is provided from the second data library as a function of the guest list, and in response to a comparison of content of the first data library to the guest profiles that are contained within the second data library.

### BRIEF DESCRIPTION OF THE DRAWINGS

FIG. 1 is a first representation of the invention.

FIG. 2 is a second representation of the invention.

FIG. 3 shows a computer display screen that appears to a guest in accordance with the “Create/edit profile” step shown in FIG. 2, whereby a guest may select a special diet and then view restricted foods that are associated with the selected special diet.

FIG. 4 shows a computer display screen that appears to a guest as a result of the guest selecting the “Proceed to individual food listings” that is shown in FIG. 3, this screen inviting the guest to activate links, wherein selection of any one link results in a cycling-through of all of the links.

FIG. 5 shows an example of a computer display screen that appears to a guest as a result of the guest choosing the “Fruits” link from the screen shown in FIG. 4, it being noted from FIG. 5 that all foods within this “Fruits” category have an initial default setting of “neutral”, and it being noted that individual food items within this “Fruits” category can be selectively changed by the guest into “Favorite,” “Prefer not to eat,” “Will not/cannot eat,” or “Life-threatening reaction,” to thus establish the guest's profile, for presentation to the “Data library of dietary restrictions and preferences” shown in FIG. 1, or to the “Database” shown in FIG. 2.

FIGS. 6 and 7 show computer display screens that implement the guest and hostess sign-in/registration functions that are shown in FIG. 2.

FIGS. 8-12 show computer display screens whereby a hostess plans a meal utilizing the present invention.

FIG. 13 shows a computer display screen whereby a hostess may view a selected guest's dietary restriction/preferences profile as stored in the databases of FIGS. 1 and 2.

FIG. 14 shows a screen that is provided by the invention in order to present a hostess with an aggregate or collection list of dietary restrictions and preference for a given event that involves a plurality of guests.

FIG. 15 shows a computer screen whereby a group administrator registers a new group on the Web-accessible database of the invention.

FIG. 16 provides functionality to allow a user to access an aggregate dietary profile of a registered group.

FIG. 17 allows a user to search for a registered group from a list of registered groups.

### DETAILED DESCRIPTION

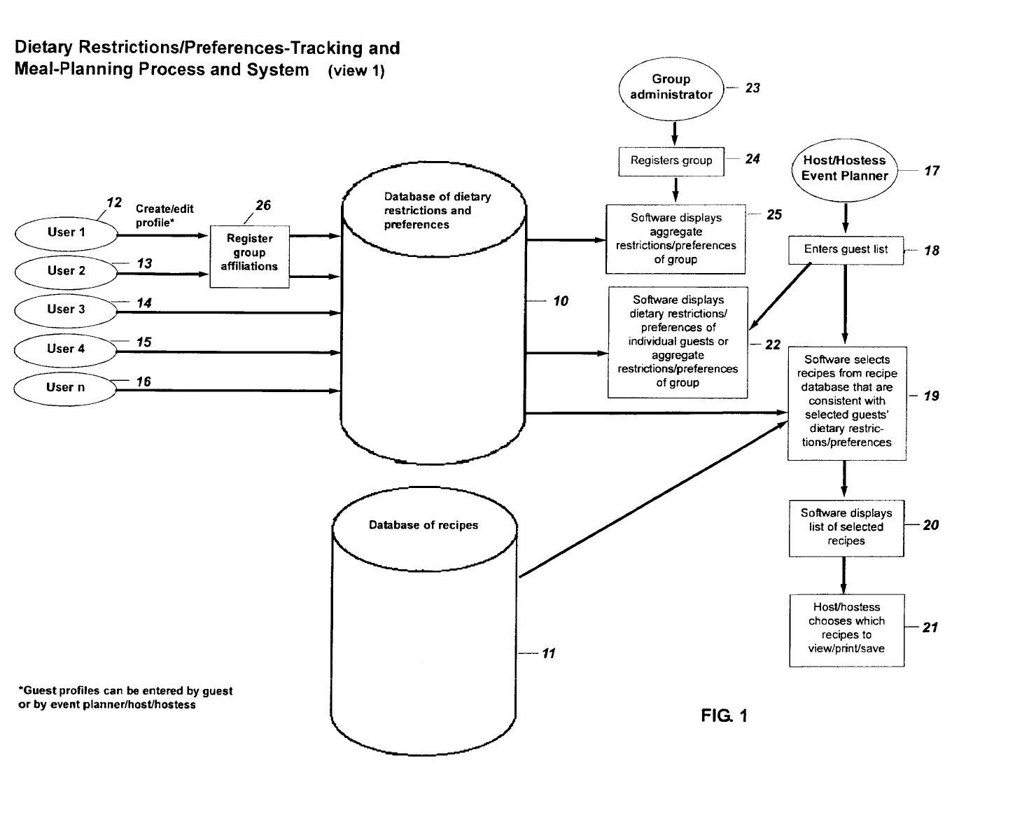

With reference to FIG. 1, two libraries or databases 10 and 11 (hereafter database) are provided.

Database 10 is a data library that contains or stores the individual dietary restrictions and preferences of a plurality of individual guests 12-16, each guest of which has created a dietary restriction/preferences profile that is stored in database 10, or each guest of which has edited a preexisting dietary restriction/preferences profile that was prior-stored in database 10. Of course, the term “guests” as used herein includes the host or hostess of a culinary event. Each user also has the opportunity to indicate his or her group affiliations, although not all users may choose to do so.

Database 11 is a data library that contains a plurality of food recipes, each recipe containing a plurality of ingredients.

In the operation of the FIG. 1 form of the invention, a hostess 17 utilizes the utility or functionality of step-18 to enter the names of list of guests that the hostess wishes to invite to an event whereat food will be served.

A step-22 is provided whereby a display of the dietary restrictions/preferences for the individual guest 12-16 is displayed, and/or an aggregate of the dietary restrictions/preferences for the group of guests 12-16 is displayed, this information being stored-in and obtained-from database 10.

Step-19 then operates to compare the individual profiles of the guests named in step-18, and as contained in database 10, to the recipes that are contained in database 11. As a result, comparison step-19 operates to generate a group or a list of recipes from database 11 that are consistent with the dietary restriction/preferences profiles of the potential guests from step-18.

Step-20 then operates to display this list of potentially acceptable recipes, and step-21 then allows hostess 17 to select or choose recipes from step-21, which selected recipes can be viewed, printed and/or saved using a computer such as a personal computer.

A group administrator 23 can register a group using step-24. Step-24 and step-26 whereby users can register their group affiliations, enables individual group members who are registered users of the system (of the Web-accessible database) to view the aggregate dietary restrictions/preferences for the group members of step-25.

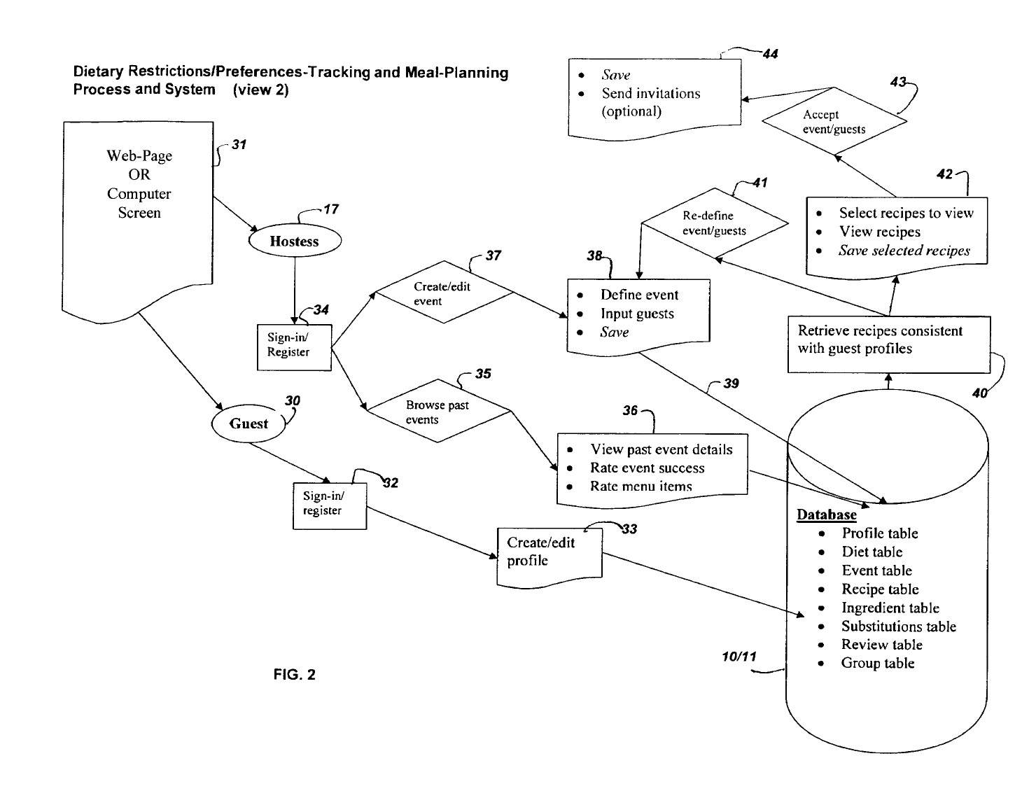

FIG. 2 provides another expression of the invention wherein a hostess 17 and one individual guest 30 utilize the Internet and a web page 31 to implement the present invention.

It should be noted that a plurality of guests 30 will likely create and store their profile in a database 11 that a hostess 17 utilizes the present invention. For example, it may be that a relatively large group of people such as the members of a club or church group have been requested to enter their dietary restriction/preferences profiles in a database 10. Thereafter an individual hostess 17 who is a member of the group can utilize the present invention when planning a party that is composed of a small number of friends who are also members of the group, or the group can use the present invention collectively to plan food dishes to bring to a potluck event.

First considering guest 30, this guest utilizes step-32 to sign-in or register with the Web-accessible database of the present invention, which guest thereafter utilizes step-33 to create or edit the dietary restriction/preferences profile of this guest 30. This new profile or edited profile is then stored in database 10/11.

Thereafter a hostess 17 can utilize database 10/11 when planning a party. First, hostess 17 utilizes step-34 from a web page 31 to sign-in or register with the Web-accessible database of the present invention.

Assuming that this particular hostess 17 has utilized the Web-accessible database of the present invention at a prior time to plan one or more culinary events, hostess 17, can, if she wishes, utilize step-35 and step-36 to retrieve and view data relative to these past events, which data is stored in database 10/11.

In planning a new event, or editing an event, hostess 17 utilizes step-37 and step-38 to define the event, input the names of the guests to be invited to the event, and then save the result in database 10/11 via path 39.

As a result of the above operation of the present invention, step-40 now operates to retrieve recipes from database 10/11 that are consistent with the dietary restriction/preferences profiles of the quests named in step-38, which profiles are also stored in database 10/11.

That is, step-40 provides hostess 17 with recipes that will be acceptable for the event being planned.

However, if hostess 17 studies the output of step-40 and determines that the event/guest list should be re-defined, step-41 provides that hostess 17 and perform such a re-definition, whereupon step-40 generates a new output by operation of the present invention.

When hostess 17 is satisfied with the output of step-40, steps 42, 43 and 44 provide for the selecting and saving of recipes from this output, the acceptance of the event and its guest list, and the saving and printing of the selected recipes, and the sending of invitations to the guests that were finally named in step-38.

The above description of FIG. 2 assumes that database 10/11 contains the dietary restriction/preferences profiles of the guests that are named in step-38 prior to the use of the present invention by hostess 17, and that step-44 operates to send invitations to these named guests.

It is also within the spirit and scope of the present invention that invitations are sent to a number of guests prior to the use of the present invention by hostess 17, and that these invitations include a request that the guests utilize steps 32 and 33 of FIG. 2 to enter their dietary restriction/preferences profiles in database 10/11. In this case hostess 17 thereafter utilizes the present invention to plan the event, and step-44 does not include sending of a second invitation to these guests. The following is a description of the content of the various tables that are listed in FIG. 2's database 10/11

Profile Table

Lists all the people who have registered and filled out a preference profile. Includes names, email addresses, passwords for guest profile access, diet preferences, food preferences/dislikes, and food intolerances.

Diet Table

Lists information about certain common diets (e.g.—low fat, low carb). Includes diet name, description, and included/excluded ingredients.

Event Table

Lists events planned by a registered user. Includes event details (host name, event name, date, type, list of guests, recipes selected) and some program information (e.g.—in progress, finalized, invitations sent).

Recipe Table

Lists recipes included in the program. Includes name, diet type (e.g.—low fat, lactose intolerant), kind of recipe (e.g.—appetizer, salad), cuisine (e.g.—Greek, Italian), occasion (e.g.—Thanksgiving, Christmas), and preparation instructions.

Ingredient Table

Lists ingredients for the recipes in the recipe table. Includes quantity, measurement, ingredient, and ingredient state (e.g.—grated, finely chopped)

Substitutions Table

Lists possible substitutes for ingredients for the recipes in the recipe table for people on restricted diets and for people who cannot or will not eat a specific individual ingredient.

Review Table

Lists reviews submitted for events and recipes. Includes recipe/event, submitter, and comments.

Group Table

Lists groups of people for standard events (e.g.—clubs, church groups). Includes group name, group password, group type, group description, group administrator, and list of guests.

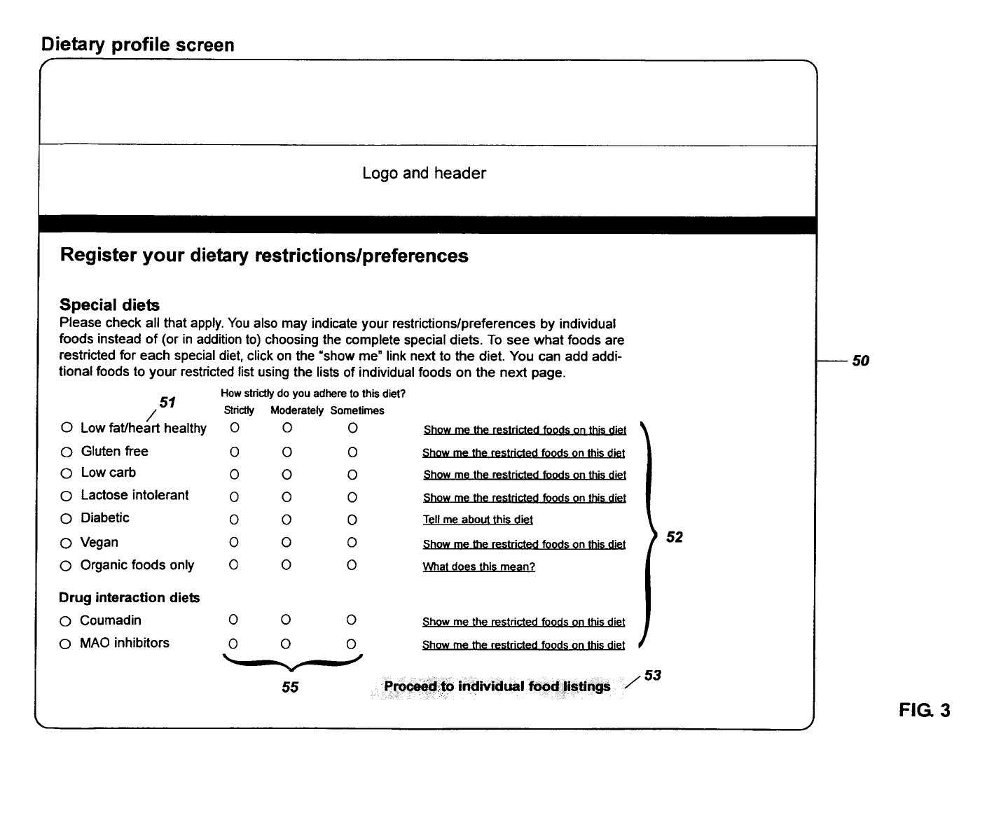

While the details of how the various functions defined in FIGS. 1 and 2 are performed are not critical to the broad aspects of the present invention, FIGS. 3, 4 and 5 show how computer display screens are presented to a guest in order to facilitate the generation of a dietary restriction/preferences profile for that guest.

With reference to FIG. 3, a screen 50 enables a guest to register the guest's dietary restrictions/preferences by using the screen's cursor (not shown) to check applicable special diet items, for example “Low fat/heart healthy” field 51. In addition, a link 52 is provided whereby the guest may elect the function “Show me the restricted foods on this diet” for any of the diet items shown on screen 50.

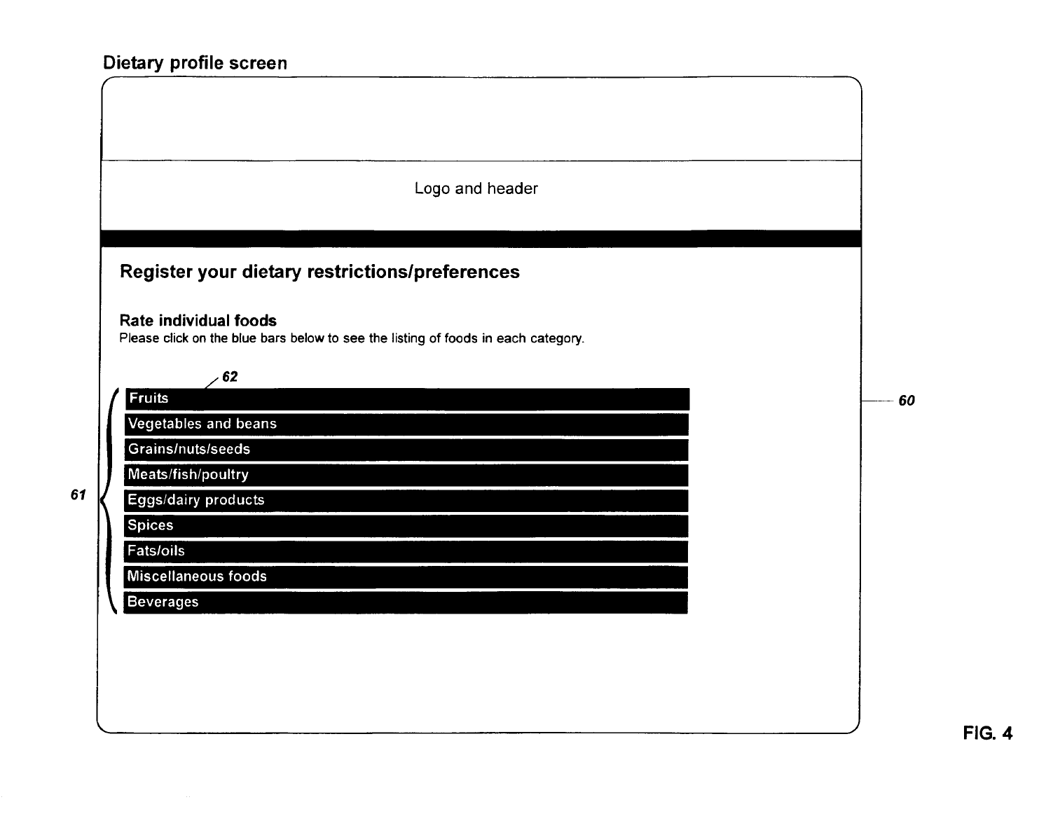

Screen 50 of FIG. 3 also provides a link 53 whereby the guest can “Proceed to individual food listings.” When the guest selects this option 53, display screen 60 shown in FIG. 4 appears to the guest.

Within area 55 of screen 50 a guest may indicate how strictly the guest adheres to a given special diet item, for example by choosing between the three categories “Strictly,” “Moderately,” or “Sometimes.”

Screen 60 of FIG. 4 shows a guest categories of food 61 (for example “Fruits”) for the guest to consider in forming their profiles.

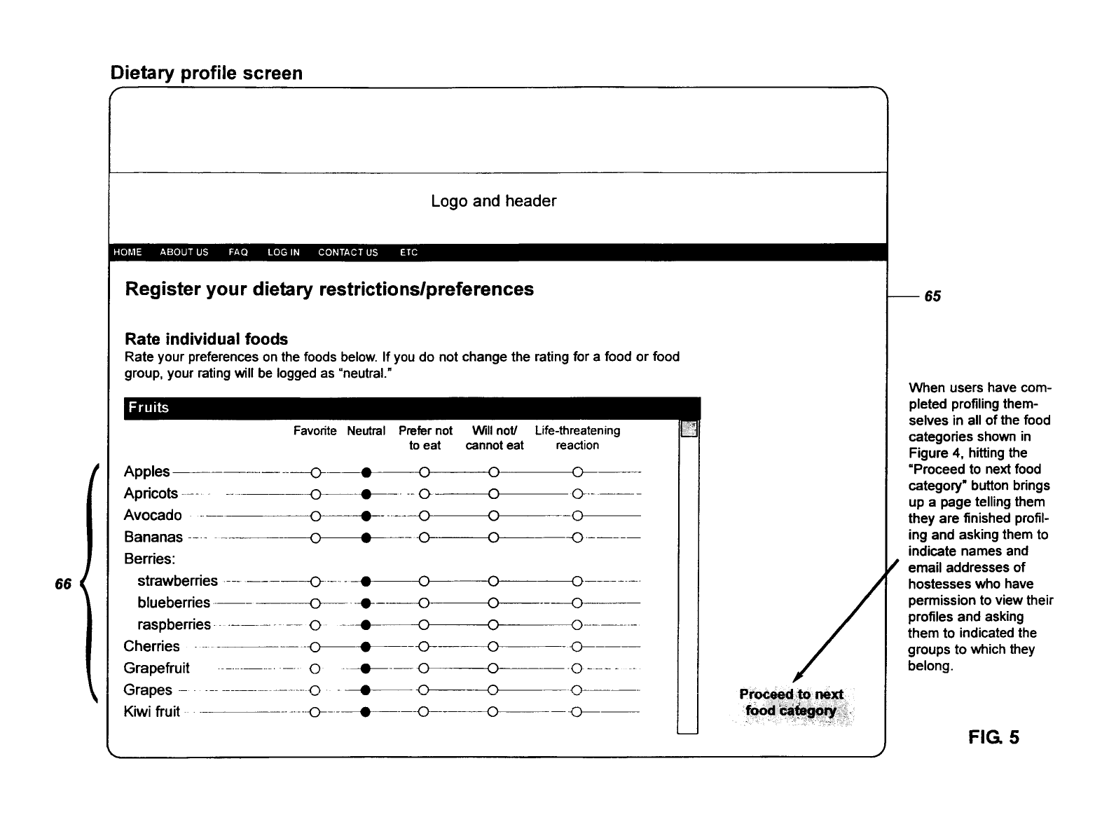

Assuming that the guest selects the link 62 to “Fruits” from screen 60, screen 65 shown in FIG. 5 appears on the guest's computer display. It should be noted that selection of any one link from screen 60 results in a FIG. 5 type screen subsequently and sequentially being presented for all of the other of the food categories that are shown in FIG. 4.

Note that in screen 65 all fruit items 66 are default-logged as “Neutral”. However the guest can change an individual fruit item, such as “Bananas”, from the “Neutral” state to a “Favorite” state, a “Prefer not to eat” state, a “Will not/cannot eat” state, or a “Life-threatening reaction” state, as is appropriate for the particular guest.

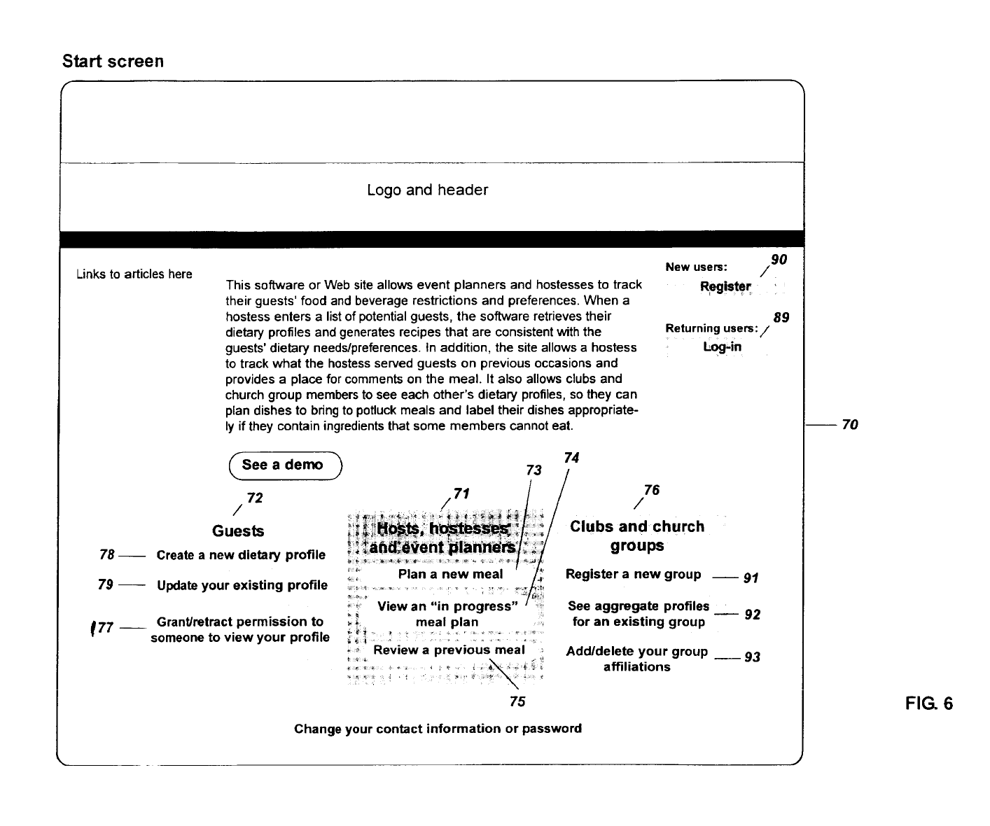

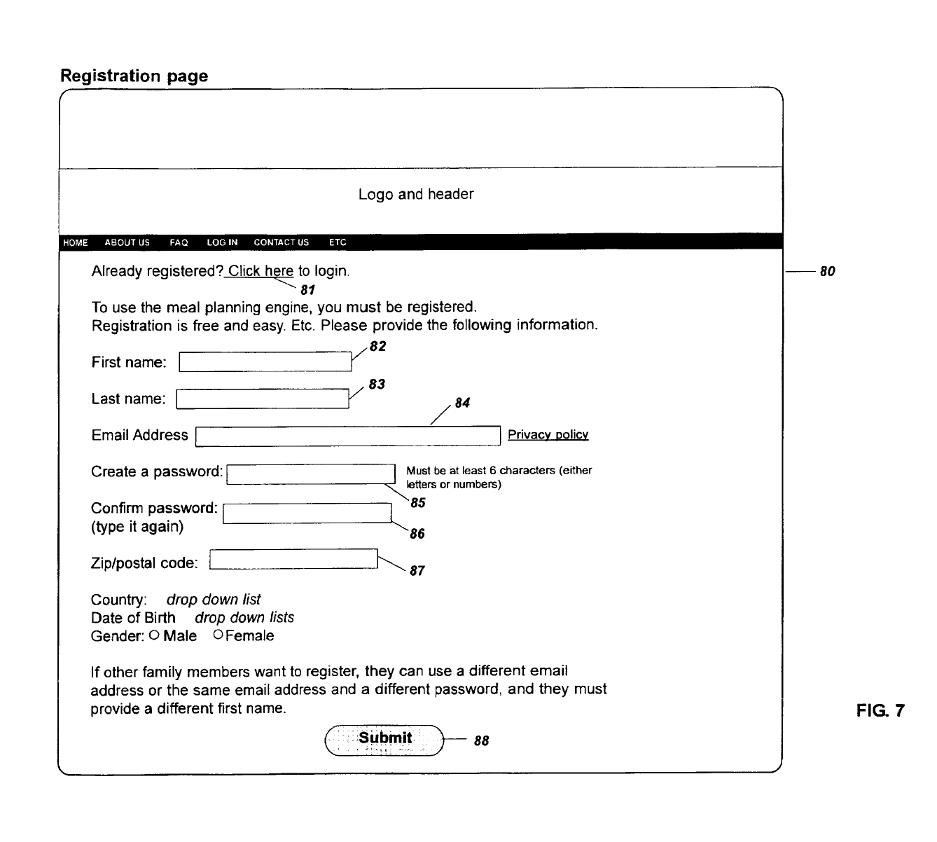

As above described relative to FIG. 2, steps 32 and 34 thereof provide functions whereby a guest 30 and a hostess 17 may sign-in/register in the Web-accessible database of the present invention. FIGS. 6 and 7 show computer display screens that implement this sign-in/registration function.

Screen 70 of FIG. 6 is a welcome screen to the Web-accessible database of the present invention. Before the Web-accessible database of the invention is used for the first time, registration button 90 must be activated to thereby take the user to the registration page shown in FIG. 7. In screen 70 a button 89 is provided whereby a hostess or guest who is already registered may log into the web site using an e-mail address and a password.

After log-in has been accomplished, screen 70 provides a first field 71 for use by a hostess, and a second field 72 for use by a guest.

Hostess field 71 contains a button 73 whereby a hostess can indicate a desire to plan a new meal, a button 74 whereby a hostess can access an “in progress” meal plan (i.e. an event that has not occurred) from database 10/11, and a button 75 whereby a hostess may review a previous meal (i.e. an event that has occurred).

Field 76 of FIG. 6 is provided for clubs and church groups, whereby activation of a button 91 enables the registration of a club/group, and whereby activation of a button 92 enables a club/group already registered on Web-accessible database to access the existing club/group. A button 93 allows users to add or delete group affiliations.

Guest field 72 of FIG. 6 contains a button 78 whereby a guest can create a new dietary restriction/preferences profile to be stored in database 10/11, and a button 79 whereby a guest can update or modify the guest's dietary restriction/preferences profile that is currently stored in database 10/11. Screen 70 of FIG. 6 also contains a button 177 whereby a guest can give permission to a hostess to view his/her dietary profile or to retract previously-given permission.

The manner in which a guest creates a new dietary restriction/preferences profile to be stored in database 10/11, or updates/modifies a dietary restriction/preferences profile that is currently stored in database 10/11 is above-described relative to FIGS. 3-5.

Screen 80 of FIG. 7 is a screen that is presented to a hostess or to a guest to enable the hostess or guest to register with the Web-accessible database of the present invention in the event that they are not already registered.

When registration is necessary, fields 82-87 of FIG. 7 enable the hostess or guest to provide the registration information as shown on screen 80, whereupon this registration information is stored in database 10/11 when field 88 is selected.

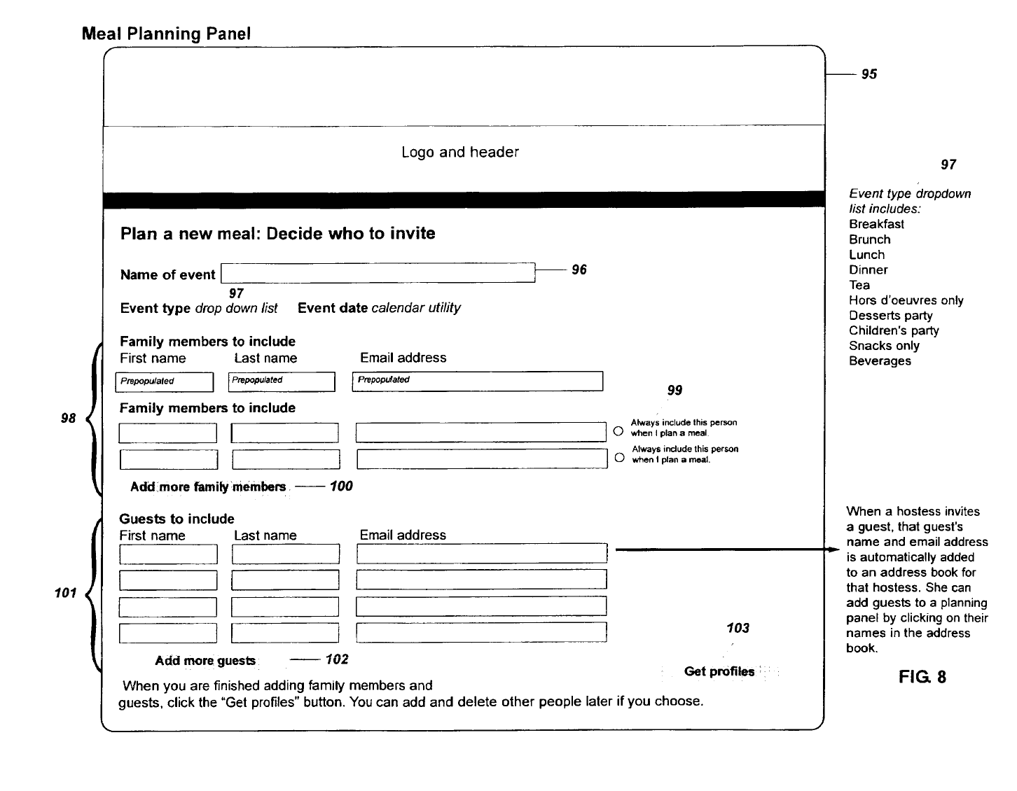

FIGS. 8-10 show examples of computer display screens whereby a hostess plans a meal utilizing the present invention.

Relative to FIG. 8, and using computer display screen 95, a hostess names the culinary event being planned using field 96, and a dropdown list 97 may be used by the hostess for selecting the event type.

Portion 98 of screen 95 enables the hostess to include up to two family members in the event wherein the first and last names and the e-mail address of the hostess is prepopulated in field 98. Field 98 also includes a button 100 that enables the hostess to include more than two family members, and also includes an option 99 enabling the hostess to always include a selected family member in all meals that are planned by the hostess utilizing the invention.

Portion 101 of screen 95 enables the hostess to list up to four guest to be invited to the event, and includes a button 102 whereby the hostess can add more guests, each guest being identified by a first name, a second name and an e-mail address.

Note that as stated in FIG. 8, when a guest's information is entered in screen field or portion 101, that information is also automatically added to the hostess' address book, and when a guest is already contained in the hostess' address book, that guest can be entered into screen field 101 by clicking on that guest's name within the address book.

When screen portions 98 and 101 have been completed, the hostess cursor-selects a button 103 that enables the dietary restriction/preference profiles of the guests that are named in screen portion 101 to be fetched from database 10 of FIG. 1 or FIG. 2.

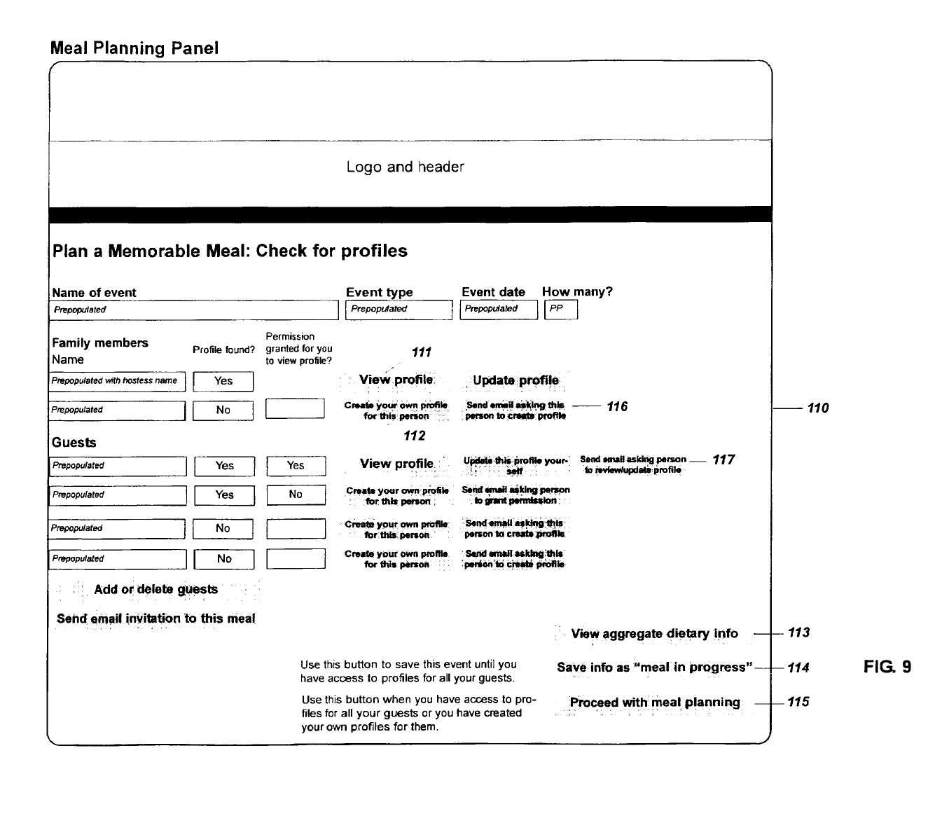

Screen 110 of FIG. 9 shows the hostess which people on her guest list already have entered dietary profiles in the database and which of these people have granted the hostess permission to view their profile.

As indicated in FIG. 9, certain fields thereof are prepopulated by information provided from screen 97 of FIG. 8.

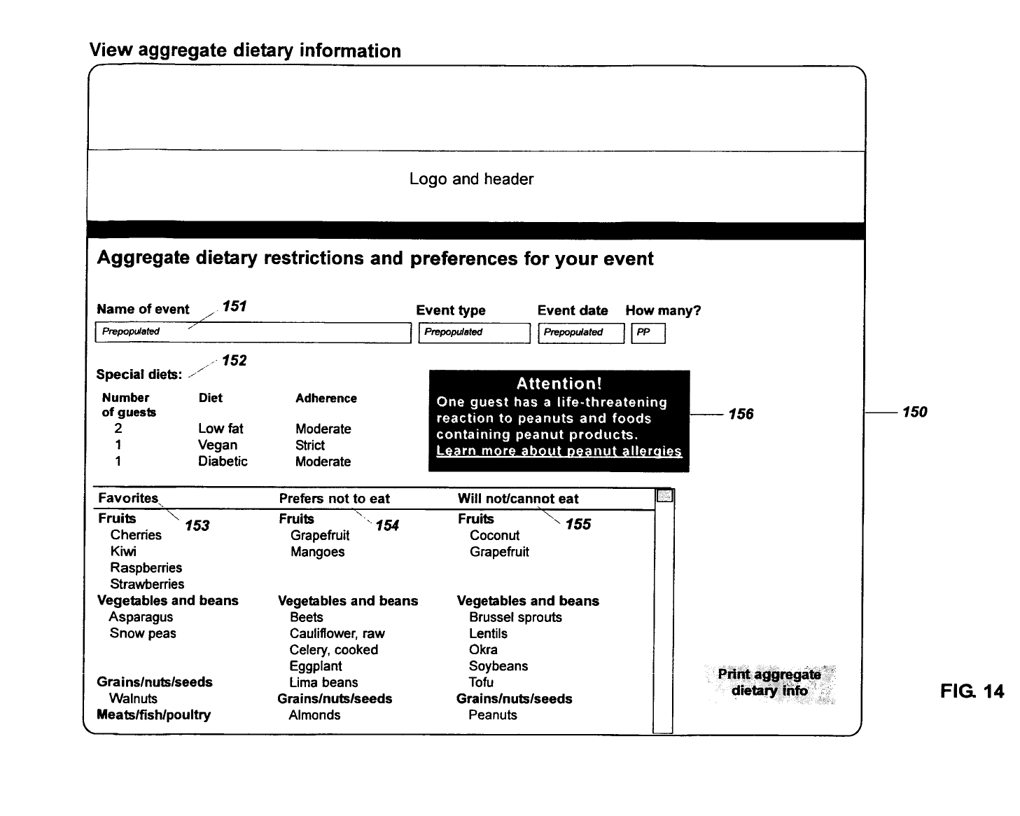

However, other fields of FIG. 9 screen 110 can be selected to enable the functions indicated therein. For example, selection of a button 111 enables the viewing of the dietary restriction/preference profile of an associated individual; selection of a button 112 allows the hostess to create her own profile for a guest or family member; selection of a button 113 displays an aggregate view of the dietary restrictions/preferences for all guests see FIG. 14); selection of a button 116 enables an e-mail message to be sent to associated guests asking that guest to create a profile as above-described; and selection of a button 117 enables an e-mail to be sent to an associated guest asking that guest to review/update an existing profile.

Screen 110 of FIG. 9 also includes a button 114 enabling the current state of screen 110 to be saved in database 10/11, and a button 115 enabling the hostess to proceed with a process of fetching recipes from database 11 based upon, or in accordance with, the currently available dietary restriction/preference profiles of the family members and guests listed on screen 110.

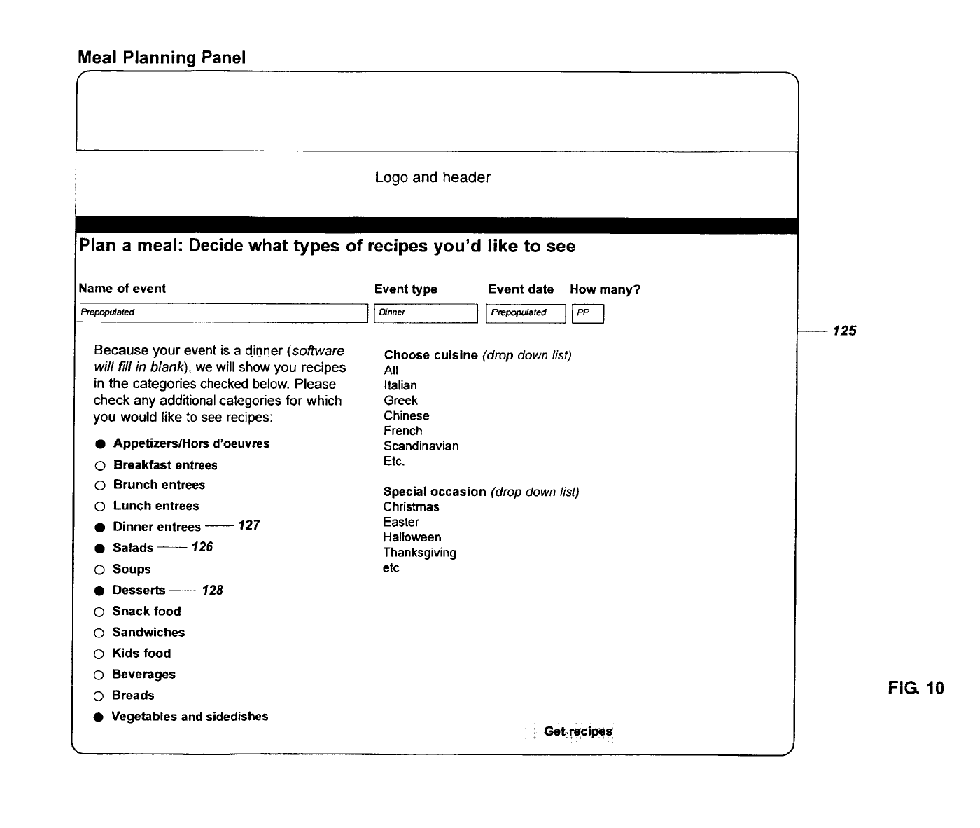

Screen 125 of FIG. 10 is provided to a hostess in order for the hostess to filter the recipes provided by step-40 of FIG. 2 to include only those recipes that conform to certain items that are pre-selected by software based upon the event type, or are cursor-selected from the categories shown in screen 125. For example, the selection of the “Salad”, “Dinner entrees” and “Desserts” categories 126, 127 and 128 would be appropriate for a dinner culinary event that would include only a salad, an entree and a dessert.

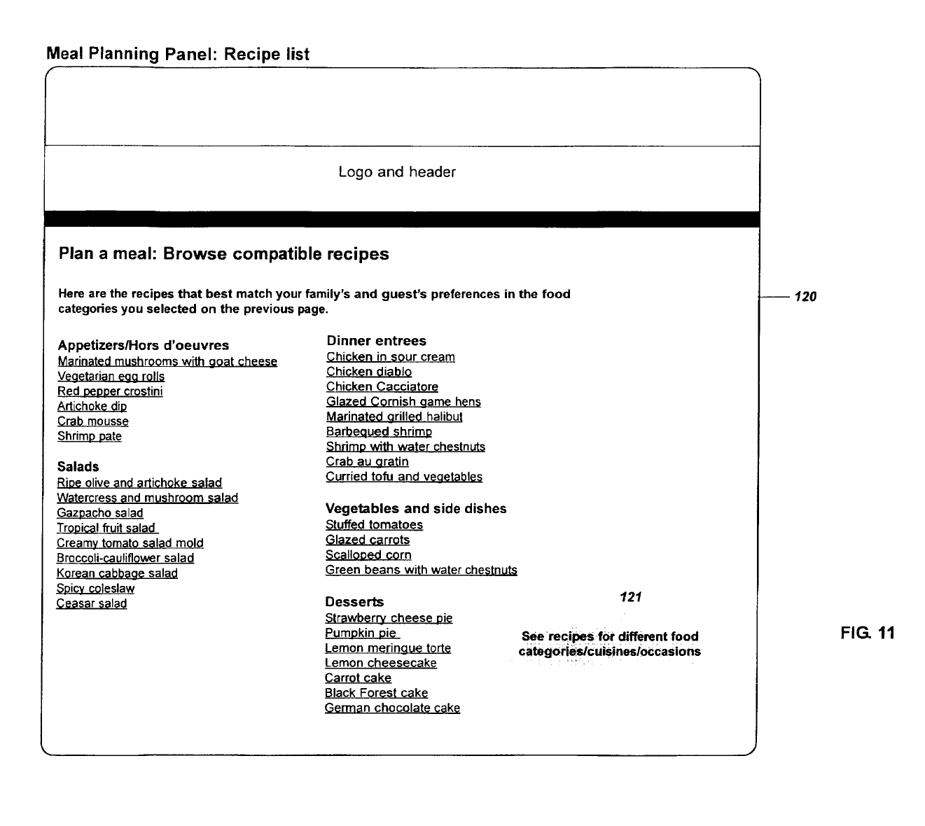

Screen 120 of FIG. 11 shows a recipe list that is provided to the hostess in response to the hostess requesting such a list by operation of step-40 shown in FIG. 2. As indicated in step-20 of FIG. 1 and step-44 of FIG. 2, this list includes the recipes from database 10 that satisfy the dietary restriction/preference profiles of the hostess, the family members and the guests that are named in screen 10 of FIG. 9. Screen 120 also includes a button 121 that enables a hostess to change the choice shown in screen 125. For example, button 121 can be used by a hostess when a small number of recipes result from operation of the invention, or when the hostess changes her mind relative to a food item.

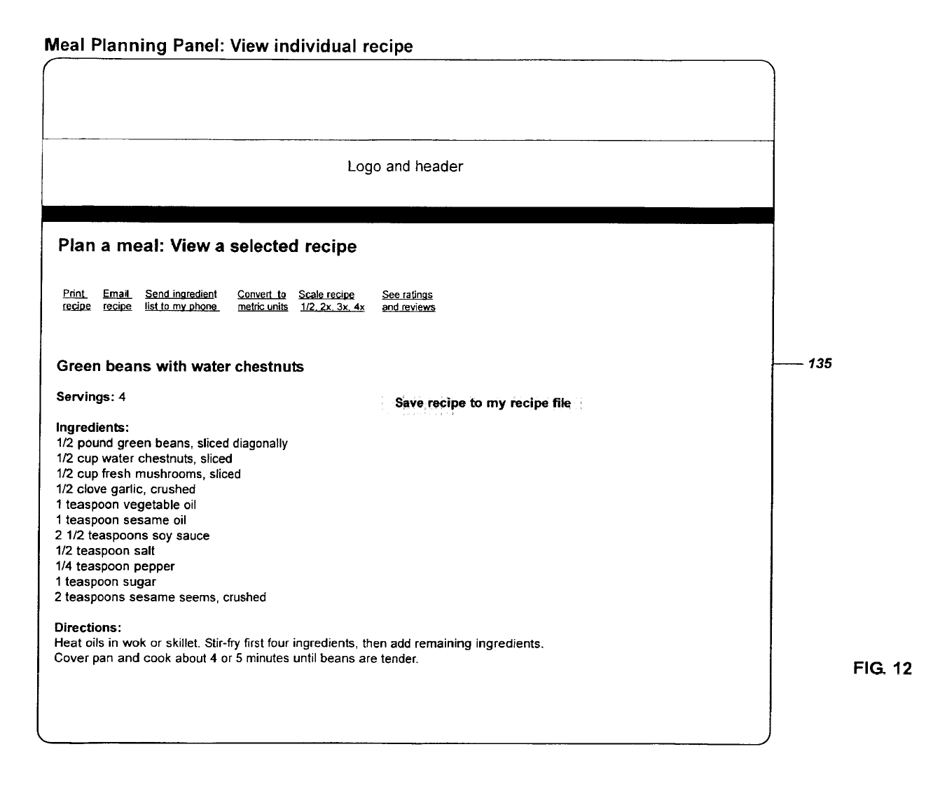

Screen 135 of FIG. 12 is a example of a recipe that would be displayed to a hostess when the hostess makes a recipe selection using step-21 of FIG. 1 or step-42 of FIG. 2.

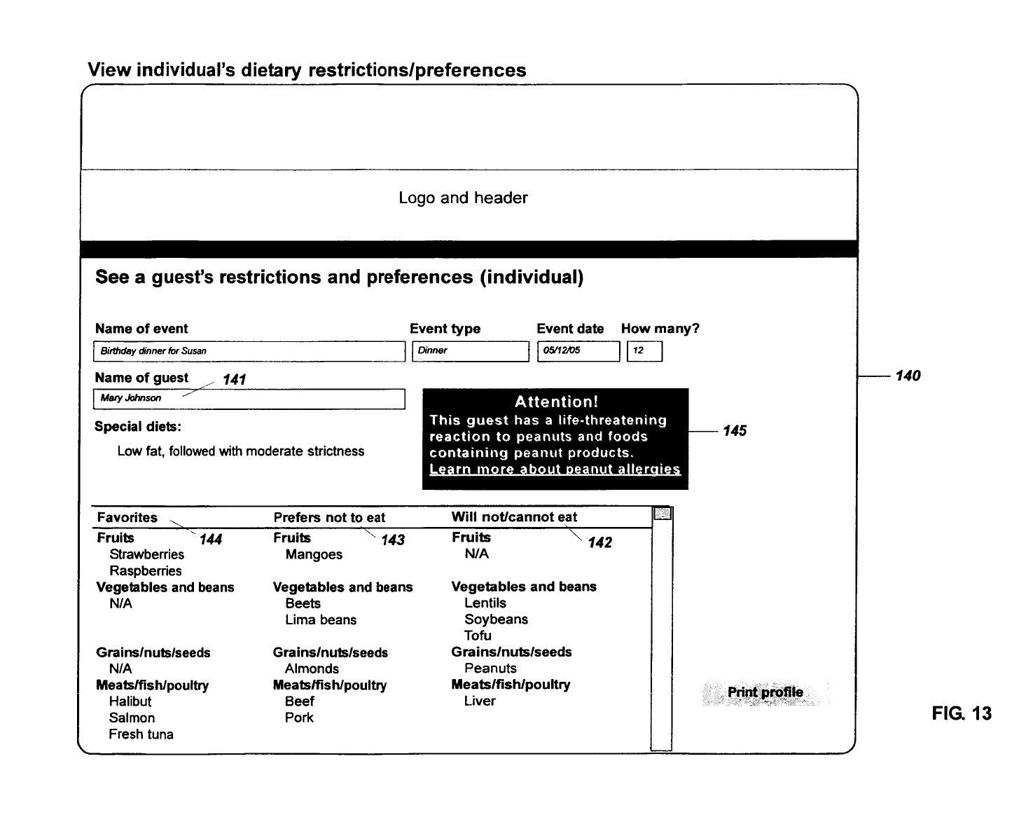

Screen 140 of FIG. 13 shows the dietary restriction/preference profile of a selected guest who is to be invited to a given event, this screen being presented to the hostess in response to selection of a field 111 from FIG. 9. For this guest 141, screen 140 displays the food items that are within the “Will not/cannot eat” category 142, the food items that are within the “Prefers not to eat” category 143, and the food items that are within the “Favorites” category 144. Screen 140 also contains a warning notice, field 145, alerting the hostess to this guest's life-threatening reaction to a particular food.

Screen 150 of FIG. 14 shows the aggregate results of the operation of the invention for an event 151 for all guests, wherein a field 152 is an aggregate showing of special diets, a field 153 is an aggregate showing of the foods that are classified as “Favorites”, a field 154 is an aggregate showing of the foods that are classified as “Prefers not to eat,” and field 155 is an aggregate showing of the foods that are classified as “Will not/cannot eat”.

In addition, screen 150 may include a button 156 that shows that for event 151 the profile of a guest includes a life-threatening situation, for example a reaction to peanuts and foods containing peanut products.

An important functionality of the invention is the ability in connection with groups, such as clubs and church groups, to view aggregate dietary restrictions/preferences for members of the group, as shown for example in FIG. 1 by step-25 and in FIG. 6 by field 76.

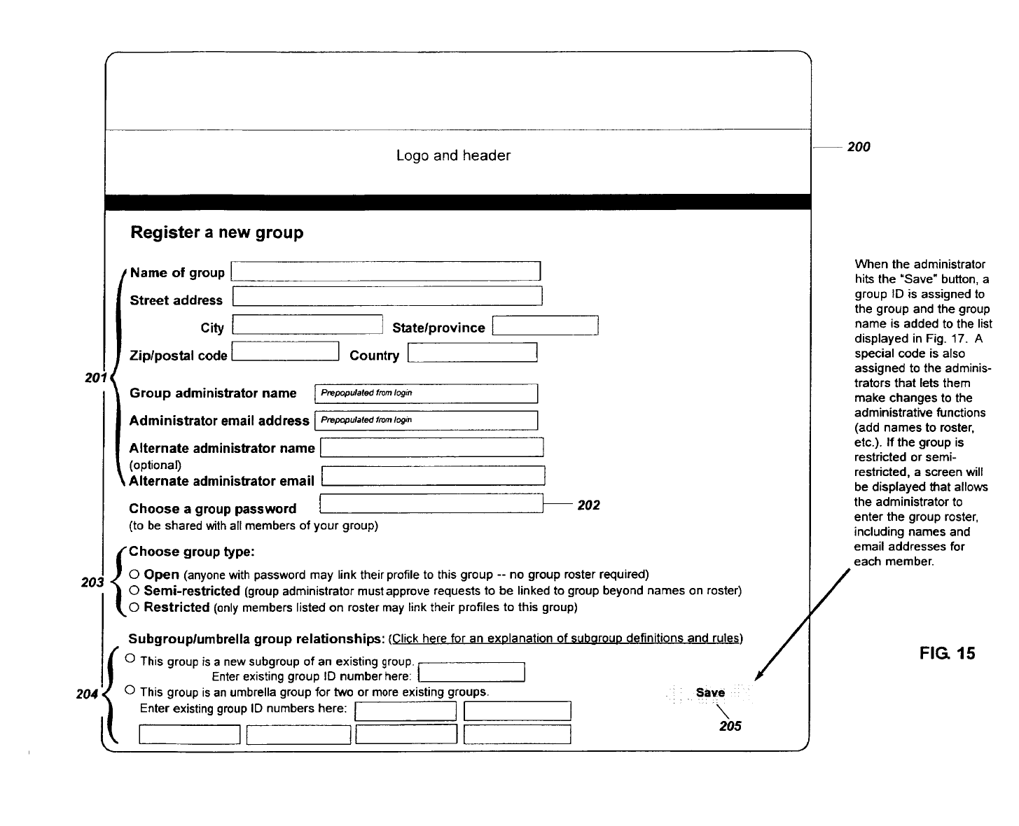

This feature of the invention is more completely shown in FIG. 15-17.

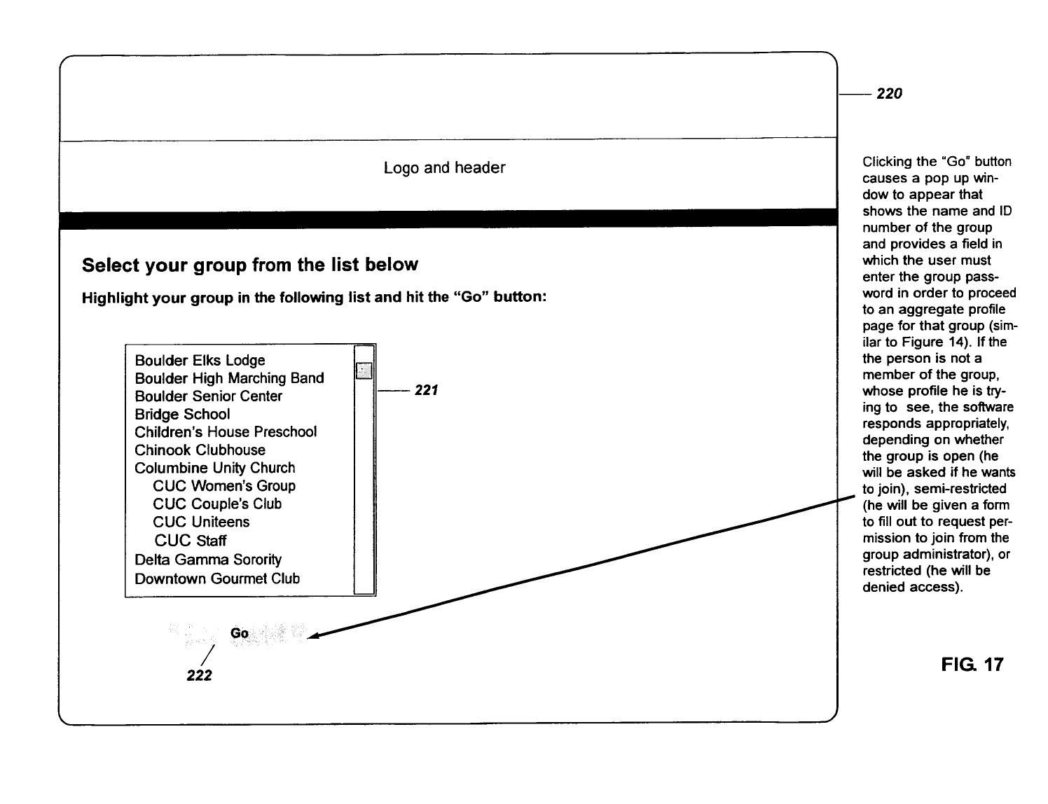

Screen 200 of FIG. 15 is accessed by using field 91 of FIG. 6. Screen 200 allows a group administrator to register a group so that group members can see an aggregate dietary profile of all members who have profiled themselves and indicated an affiliation with the group. The administrator provides basic group information in fields 201. The administrator can also appoint an alternate administrator who can perform administrative duties (for example, approving requests for a user to affiliate his or her profile with the group). In field 202, the administrator designates a password that will be used by all group members (who still must log in to the system using their individual passwords) to access the group aggregate profile. Field 203 allows the administrator to choose the type of group as: Open (anyone with password may link their profile to this group—no group roster is required); Semi-restricted (group administrator must approve requests to be linked to group beyond names on roster); or Restricted (only members listed on roster may link their profiles to this group). Fields 204 allow the administrator to designate the group as a subgroup of another group or as an umbrella group of two or more existing groups. When the administrator clicks the field 205 “Save” button, a group ID is assigned to the group and the group name is added to the list displayed in FIG. 17. A special code is also assigned to the administrators that lets them make changes to the administrative functions (add names to roster, approve requests to be added to roster, etc.). If the group is restricted or semi-restricted, a screen will be displayed that allows the administrator to enter the group roster, including names and email addresses for each member.

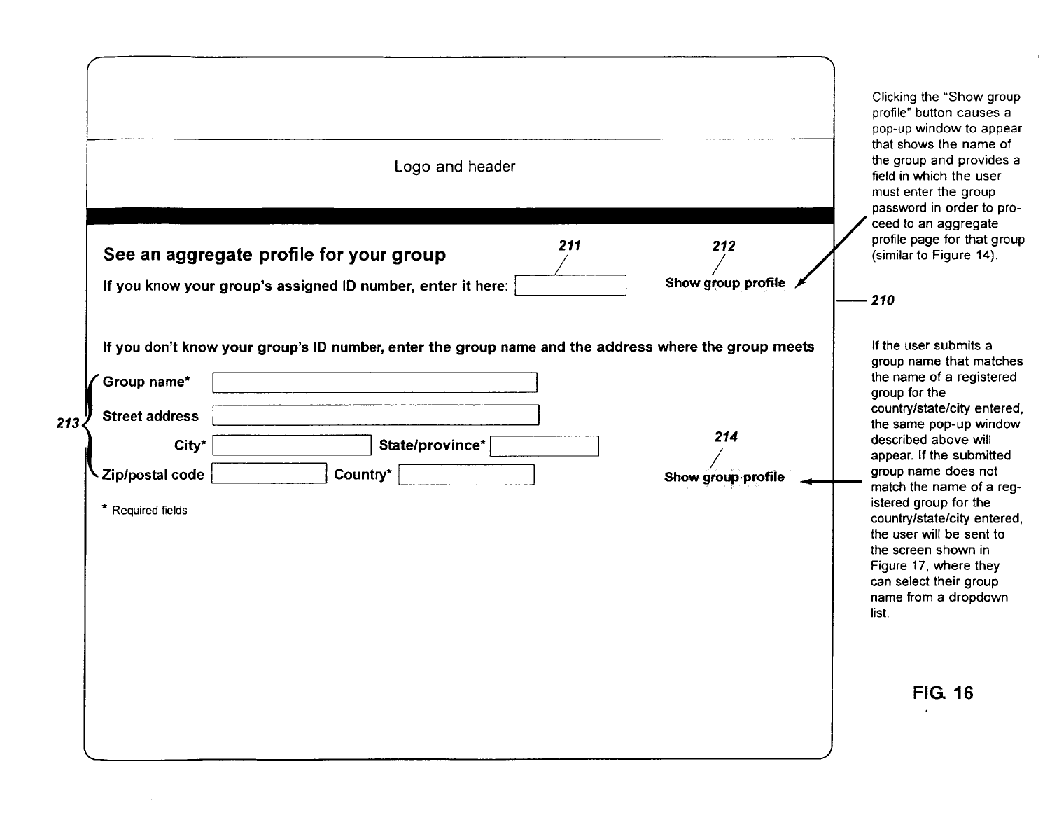

Screen 210 of FIG. 16 is access by using button 92 of FIG. 6. If a group member wants to see the aggregate dietary profile of their group, they can access in one of two ways. They can enter the assigned group ID number in field 211 and click the 212 “Show group profile” button (which causes a pop-up window to appear that shows the name of the group and provides a field in which the user must enter the group password in order to proceed to an aggregate profile page for that group similar to the one show in FIG. 14), or if they do not know the group ID number, they can fill in the group information fields 213 and click the 214 “Show group profile” button. If the user submits a group name that matches the name of a registered group for the country/state/city entered, the same pop-up window described above will appear. If the submitted group name does not match the name of a registered group for the country/state/city entered, the user will be sent to the screen shown in FIG. 17, where they can select their group name from a dropdown list.

Screen 220 of FIG. 17 provides a dropdown list 221 containing the names of groups registered for the country/state/city indicated in fields 213 of FIG. 16. Clicking the 222 “Go” button causes a pop-up window to appear that shows the name and ID number of the group and provides a field in which the user must enter the group password in order to proceed to an aggregate profile page for that group (similar to FIG. 14). If the person is not a member of the group, whose profile he is trying to see, the software responds appropriately, depending on whether the group is open (he will be asked if he wants to join), semi-restricted (he will be given a form to fill out to request permission to join from the group.

What is claimed is:

1. A system for planning food to be served at an event that is compatible with the food preferences and/or restrictions of at least a substantial portion of the potential attendees of the event comprising:
a computer-accessible database system comprising:
a first portion for storing a plurality of food profiles, each food profile being associated with a different individual and defining the food restrictions and/or preferences of such an individual;
a second portion for storing a plurality of recipes, at least some of said plurality of recipes being compatible with food restrictions and/or preferences that can potentially be identified in an individual's food profile; and
a computer-based interface associated with said computer-accessible database system for allowing a user to interact with said computer-accessible database system for use in planning an event at which food is to be served.

2. A system, as claimed in claim 1, wherein:
said computer-based interface comprises a potential attendee interface that allows a potential attendee of an event to create a food profile that is individualized to said potential attendee.

3. A system, as claimed in claim 1, wherein:
said computer-based interface comprises a potential attendee interface that allows a potential attendee of an event to alter a pre-existing food profile that is associated with the potential attendee.

4. A system, as claimed in claim 1, wherein:
said computer-based interface comprises a potential attendee interface that allows a potential attendee of an event to provide an identified host/hostess of the event with access to a food profile associated with the potential attendee.

5. A system, as claimed in claim 1, wherein:
said computer-based interface comprises a host/hostess interface that allows a host/hostess of an event to identify potential attendees of the event.

6. A system, as claimed in claim 1, wherein:
said computer-based interface comprises a host/hostess interface that allows a host/hostess of an event to determine whether or not said host/hostess has access to a food profile associated with each potential attendee of the event.

7. A system, as claimed in claim 6, wherein:
said host/hostess interface allows a host/hostess to e-mail a potential attendee of the event to request that said potential attendee establish a food profile and/or grant access to an existing food profile for said potential attendee to said host/hostess.

8. A system, as claimed in claim 1, wherein:
said computer-based interface comprises a host/host interface that allows a host/hostess of an event to identify whichever recipes are in said second portion of said computer-accessible database system are compatible with at least a substantial portion of the potential attendees of the event.

9. A system, as claimed in claim 1, wherein:
said computer-based interface comprises a host/host interface that allows a host/hostess of an event to receive recipes for whichever recipes are in said second portion of said web-accessible database system are compatible with at least a substantial portion of the potential attendees of the event.

10. A method for planning food to be served at an event that is compatible with the food preferences and/or restrictions of at least a substantial portion of the potential attendees of the event comprising:
receiving, at a device associated with a host/hostess of a proposed event at which food is to be served and that is capable of computer-based communication, an interface that provides the host with the ability to identify the proposed event, a proposed attendee list for the event, a type of meal, and courses associated with the meal;
transmitting, from a device associated with a host/hostess of a proposed event at which food is to be served and that is capable of computer-based communication, event identification information and a proposed attendee list for the event;
receiving, at a device associated with a host/hostess of a proposed event at which food is to be served and that is capable of computer-based communication, a list for each course of the proposed type of meal of possible recipes that, based on food restrictions and/or preferences provided by at least some of the proposed attendees, is consistent with the dietary preferences and/or restriction of at least a substantial portion of the proposed attendees.

11. A method, as claimed in claim 10, further comprising:
receiving, at a device associated with a proposed attendee of the event at which food is to be served and that is capable of computer-based communication, an interface for identifying dietary restrictions and/or preferences.

12. A method, as claimed in claim 11, further comprising:
transmitting, from a device associated with a proposed attendee of the event at which food is to be served and that is capable of computer-based communication, dietary restrictions and/or preference for the proposed attendee.

13. A method, as claimed in claim 10, further comprising:
transmitting, from a device associated with a host/hostess of the event at which food is to be served and that is capable of computer-based communication, a recipe selected from a list of recipes for a course of the type of meal.

14. A method, as claimed in claim 13, further comprising:
receiving, at a device associated with a host/hostess of the event at which food is to be served and that is capable of computer-based communication, an instruction set for said recipe selected from said list of recipes.

15. A method, as claimed in claim 10, further comprising:
receiving, at a device associated with a host/hostess of the event at which food is to be served and that is capable of computer-based communication, an interface for reviewing data associated with past events at which food was served.

16. A method, as claimed in claim 10, further comprising:
receiving, at a device associated with a host/hostess of the event at which food is to be served and that is capable of computer-based communication, an interface for reviewing individual or aggregate dietary preferences and/or restrictions for potential attendees of the event.

17. A method, as claimed in claim 10, further comprising:
receiving, at a device associated with an individual that is a member of a group of individuals that have each provided a food profile to a database system and that is capable of computer-based communication, aggregate dietary restrictions and/or preferences for said group or a subset of said group that are planning an event at which food is to be served.

18. A system for storing dietary profiles of individuals and providing access to one or more stored dietary profiles comprising:
a computer-accessible database for storing a plurality of food profiles, each food profile being associated with a different individual and defining the food restrictions and/or preferences of such an individual;
a computer-based interface associated with said computer-accessible database system for allowing an individual to interact with said computer-accessible database system to define a food profile that is associated with said individual.

19. A system, as claimed in claim 18, wherein:
said computer-based interface also allowing an individual to modify a pre-existing food profile that is associated with said individual.

20. A system, as claimed in claim 18, wherein:
said computer-based interface also for allowing an individual to permit a different individual to access their food profile.

21. A system, as claimed in claim 18, wherein:
said computer-based interface comprising a second party interface that allows a different individual to access a food profile associated with said individual.

22. A system, as claimed in claim 18, wherein:
said computer-based interface comprises at least one of the following: a personal computer, a device for communicating over a computer network, and a device for communicating over the Web.
